(19) United States
(12) Patent Application Publication
(10) Pub. No.: US 2015/0091827 A1
(43) Pub. Date: Apr. 2, 2015

(54) TOUCH PANEL

(71) Applicant: Novatek Microelectronics Corp., Hsinchu (TW)

(72) Inventor: Shun-Li Wang, Hsinchu City (TW)

(21) Appl. No.: 14/487,106

(22) Filed: Sep. 16, 2014

Related U.S. Application Data
(60) Provisional application No. 61/886,038, filed on Oct. 2, 2013.

(30) Foreign Application Priority Data
Jul. 9, 2014 (TW) 103123649

(51) Int. Cl. G06F 3/041

(52) U.S. Cl. CPC G06F 3/041
USPC 345/173

(57) ABSTRACT

A touch panel includes a substrate and an electrode layer. The substrate includes a first substrate region. The electrode layer includes a plurality of first repetitive units sequentially arranged in a first direction on the first substrate region of the substrate. Each of the first repetitive units corresponds to integral pairs of channels of plural pairs of channels and includes a first electrode and a second electrode. The first electrode and the second electrode are electrically independent from each other. The first electrode includes a plurality of first branch regions, and the second electrode includes at least one second branch region. The first branch regions and the at least one second branch region are alternately arranged on the first substrate region of the substrate. Two edges of each of the first repetitive units in the first direction respectively belong to the first branch regions.

### CROSS-REFERENCE TO RELATED APPLICATION

This application claims the priority benefits of U.S. provisional application Ser. No. 61/886,038, filed on Oct. 2, 2013 and Taiwan application serial no. 103123649, filed on Jul. 9, 2014. The entirety of each of the above-mentioned patent applications is hereby incorporated by reference herein and made a part of this specification.

### FIELD OF THE INVENTION

The invention relates to a touch panel, and more particularly, to a single-electrode layer type touch panel.

### DESCRIPTION OF RELATED ART

A conventional capacitive touch panel is often constituted by a plurality of touch boards and frequently has a single-layer or a double-layer structure. FIG. 1 is a schematic diagram illustrating a capacitive touch panel 100 with the single-layer structure. The touch panel 100 includes a substrate 110 and a single-layer electrode layer 120 that includes a plurality of sensing units G100, each of which includes an electrode 122 and an electrode 124. To perform a touch detection action on the capacitive touch panel 100, the capacitive touch panel 100 provides a plurality of channels E1 to E8 and F1 to F8. Each of the channels E1 to E8 is constituted by a triangular electrode 122, and each of the channels F1 to F8 is constituted by a triangular electrode 124. That is, each of the sensing units G100 corresponds to one of the channels E1 to E8 and one of the channels F1 to F8. In one single sensing unit G100, the electrode 122 and the electrode 124 are right triangles each occupying the same measure of area, while the hypotenuses of the two triangles adjoin and the shape of the two triangles are arranged in an upside down manner relative to each other. A width of the electrode 122 decreases in a second direction D2 from a side S102 to a side S104, and a width of the electrode 124 decreases in the second direction D2 from the side S104 to the side S102. Thereby, each of the channels E1 to E8 corresponds to the area of the electrode 122 touched by a user, so as to obtain a sensing signal; each of the channels F1 to F8 corresponds to the area of the electrode 124 touched by a user, so as to obtain another sensing signal Through the sensing signal obtained through any of the channels E1 to E8 and F1 to F8, the touch panel 100 is able to determine the touch location of the user.

FIG. 2 schematically illustrates sensing signals of the touch panel 100. With reference to FIG. 1 and FIG. 2, when the user touches a touch point T1, the channels E5 to E7 and the channels F5 to F7 receive signals SE5 to SE7 and SF5 to SF7. Thereby, the touch panel 100 determines the touch point T1 is located between the channels E6 and F6. When the user touches a touch point T2, the channels E6 to E8 and the channels F7 to F8 receive signals SE6 to SE8 and SF7 to SF8. Thereby, the touch panel 100 determines the touch point T2 is located between the channels E7 and F8. When the user touches a touch point T3, the channels E7 to E8 and the channel F8 receive signals SE7 to SE8 and SF8. Thereby, the touch panel 100 determines the touch point T3 is located within the channel E8 rather than in the channels F1 to F8. Thereby, when the user performs the touch action along a trajectory T, the touch panel 100 would obtain a trajectory that deviates from the trajectory T at its end portion, which is the so-called “drifting”. In light of the foregoing, the touch panel 100 may not sense the touch action accurately; particularly, the touch action around the edge of the touch panel 100 cannot be precisely detected in most cases.

### SUMMARY OF THE INVENTION

The invention is directed to a touch panel that is characterized by exceptional sensing accuracy

In an embodiment of the invention, a touch panel that includes a substrate and an electrode layer is provided. The substrate includes a first substrate region. The electrode layer includes a plurality of first repetitive units sequentially arranged in a first direction on the first substrate region of the substrate. Each of the first repetitive units corresponds to integral pairs of channels of plural pairs of channels and includes a first electrode and a second electrode. The first electrode and the second electrode are electrically independent from each other. The first electrode includes a plurality of first branch regions, and the second electrode includes at least one second branch region. The first branch regions and the at least one second branch region are alternately arranged on the first substrate region of the substrate. Two edges of each of the first repetitive units in the first direction respectively belong to the first branch regions.

According to an embodiment of the invention, each of the first repetitive units is a first-type repetitive unit corresponding to one pair of the channels or a second-type repetitive unit corresponding to two pairs of the channels. Each of the first repetitive units is the first-type repetitive unit. Alternatively, each of the first repetitive units is the second-type repetitive unit.

According to an embodiment of the invention, each of the first repetitive units is symmetrical about a median of each of the first repetitive units.

According to an embodiment of the invention, each of the first branch regions in each of the first repetitive units has a pointed structure. A narrowest portion and a widest portion of the pointed structure are respectively adjacent to a first side and a second side of the touch panel. Besides, each of the at least one second branch region has a pointed structure, and a narrowest portion and a widest portion of the pointed structure are respectively adjacent to the second side and the first side of the touch panel. In each of the first repetitive units, the first branch regions include two partial pointed structures respectively located at two sides of the first repetitive unit and at least one complete pointed structure located between the two partial pointed structures. The at least one second branch region includes at least one complete pointed structure respectively located between the first branch regions. Each of the partial pointed structures is a right triangle. Each of the complete pointed structures is a non-right triangle, and the non-right triangle is an isosceles triangle.

According to an embodiment of the invention, each of the first repetitive units is divided into at least one first basic unit respectively corresponding to one pair of the channels among N pairs of the channels.

According to an embodiment of the invention, each of the first repetitive units is a first-type repetitive unit including one first basic unit or a second-type repetitive unit including two first basic units.

According to an embodiment of the invention, an i^{th} first basic unit equivalently has Xi sets of complete pointed structures, and i=1˜N. If the first repetitive unit to which the i^{th} first basic unit belongs is the first-type repetitive unit, Xi=Pi. If the first repetitive unit to which the i^{th} first basic unit belongs is the second-type repetitive unit, Xi=(Pi+0.5), and Pi is a positive integer.

According to an embodiment of the invention, each of X₁ and X_{N} equals to P_{M}, each of X₂ to X_{N-1} equals to P_{S}, and P_{M}≦P_{S}.

According to an embodiment of the invention, in the first basic unit belonging to the first-type repetitive unit, the first branch regions include two partial pointed structures respectively located at two sides of the first repetitive unit and (Xi−1) complete pointed structure located between the two partial pointed structures. The at least one second branch region includes Xi complete pointed structures respectively located between adjacent two of the two partial pointed structures and the (Xi−1) complete pointed structures of the first branch region, wherein Xi is a positive integer.

According to an embodiment of the invention, in the first basic unit belonging to the second-type repetitive unit, the first branch regions include Xi complete pointed structures and one partial pointed structure, and the partial pointed structure is adjacent to one of two sides of the at least one first basic unit. The at least one second branch region includes Xi complete pointed structures and one partial pointed structure, and the Xi complete pointed structures are respectively located between two of the first branch regions. The partial pointed structure is adjacent to the other one of the two sides of the at least one first basic unit, and Xi is a positive integer.

According to an embodiment of the invention, the substrate further includes a second substrate region, and the electrode layer further includes a plurality of second repetitive units sequentially arranged in the first direction on the second substrate region of the substrate. Each of the second repetitive units corresponds to integral pairs of channels of the plural pairs of channels and includes a third electrode and a fourth electrode. The third electrode and the fourth electrode are independent from each other. The third electrode includes at least one third branch region, and the fourth electrode includes at least one fourth branch region. The at least one third branch region and the at least one fourth branch region are alternately arranged on the second substrate region of the substrate. Here, two edges of each of the second repetitive units respectively belong to the third branch regions.

According to an embodiment of the invention, a layout of the first repetitive units of the electrode layer on the first substrate region and a layout of the second repetitive units of the electrode layer on the second substrate region respectively are symmetrical to each other.

According to an embodiment of the invention, a layout of the first repetitive units of the electrode layer on the first substrate region and a layout of the second repetitive units of the electrode layer on the second substrate region respectively are asymmetrical to each other and are translationally shifted relative to each other along a second direction perpendicular to the first direction.

According to an embodiment of the invention, in each of the first repetitive units, each of the at least one second branch region of the second electrode is located between two adjacent first branch regions of the first branch regions of the first electrode in the same one of the first repetitive units.

According to an embodiment of the invention, the first electrodes and the second electrodes in the first repetitive units are shaped as sawteeth, forks, combs, or fingers.

In another embodiment of the invention, a touch panel that includes a substrate and an electrode layer is provided. The substrate includes a first substrate region. The electrode layer includes a plurality of first repetitive units sequentially arranged in a direction on the first substrate region of the substrate. Each of the first repetitive units corresponds to integral pairs of channels of plural pairs of channels and includes a first electrode and a second electrode. The first electrode and the second electrode are independent from each other. The first electrode includes a plurality of first branch regions. The second electrode includes at least one second branch region. The first branch regions and the at least one second branch region are alternately arranged on the first substrate region of the substrate. In each of the first repetitive units, each of the at least one second branch region of the second electrode is located between two adjacent first branch regions of the first branch regions of the first electrode in the same of the first repetitive units.

In view of the above, the repetitive units in the touch panel described herein are comprised of the first electrode and the second electrode constituted by one-layer electrode patterns, each of the repetitive units corresponds to integral pairs of channels, and the branch regions of the first electrode are located at two sides of the corresponding repetitive unit. The branch regions at the edges have the partial pointed structures that occupy a relatively small area; hence, if the touch point is located at the edge, one pair of channels (rather than one channel) can still receive the sensing signal, and thus the issue of the unfavorable sensing performance at the edge of the touch panel can be resolved.

Several exemplary embodiments accompanied with figures are described in detail below to further describe the invention in details.

### BRIEF DESCRIPTION OF THE DRAWINGS

FIG. 1 is a schematic diagram illustrating a conventional touch panel.

FIG. 2 schematically illustrates signals of the touch panel depicted in FIG. 1.

FIG. 3 to FIG. 8 are schematic diagrams illustrating repetitive units according to several embodiments of the invention.

FIG. 9 to FIG. 11 illustrate connections of branch regions according to several embodiments of the invention.

FIG. 12 illustrates a touch panel according to an embodiment of the invention.

FIG. 13 schematically illustrates signals of the touch panel depicted in FIG. 12.

FIG. 14 to FIG. 18 illustrate a touch panel according to several embodiments of the invention.

### DETAILED DESCRIPTION OF DISCLOSED EMBODIMENTS

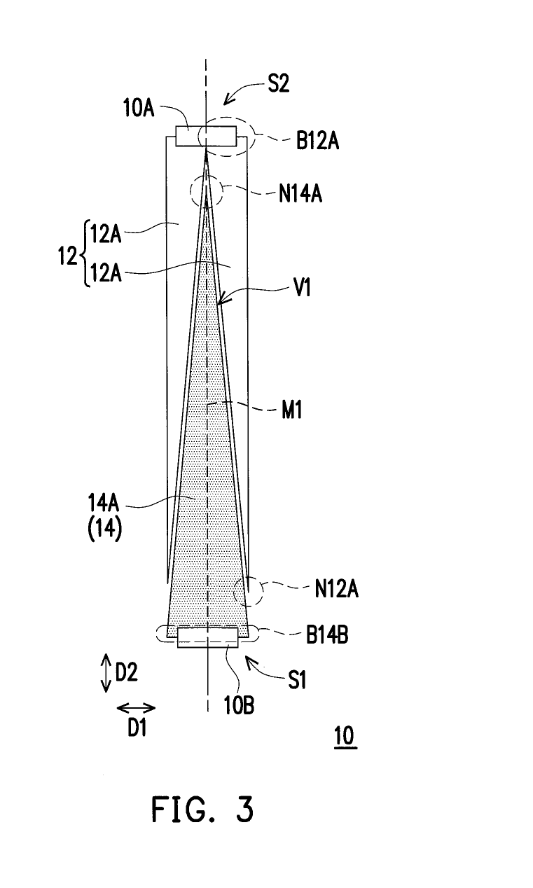

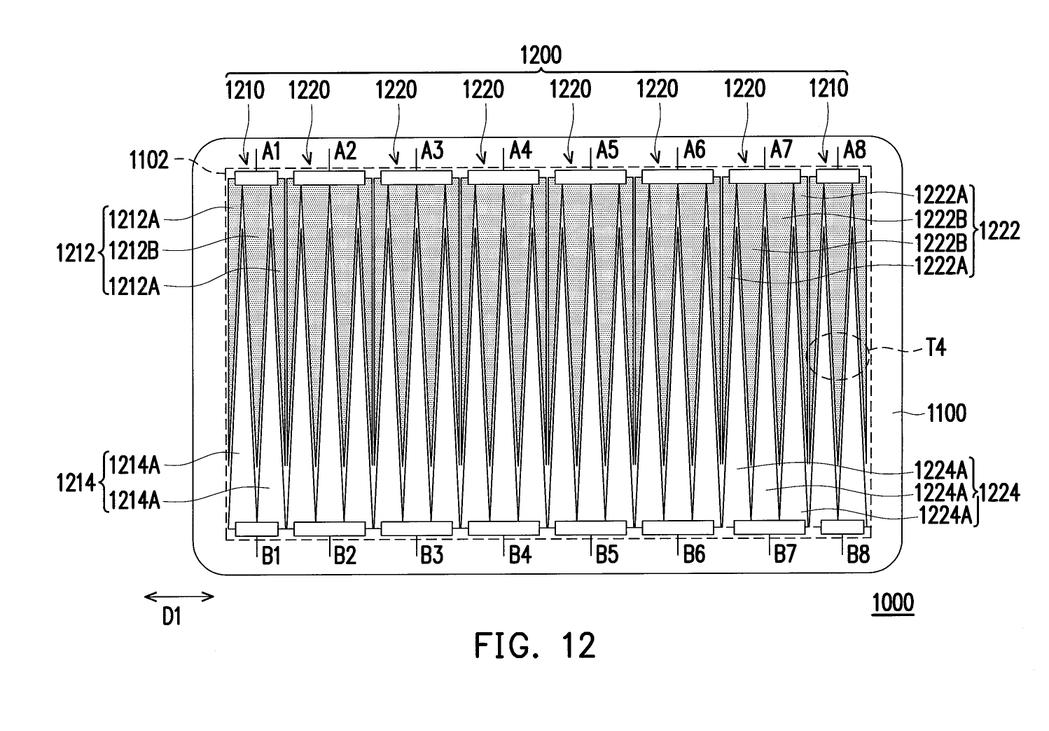

The touch panel with the single-layer electrode structure is implemented in form of repetitive units capable of performing touch sensing actions, and the repetitive units are formed by dividing one electrode layer into electrode patterns. Hence, in the following embodiments, each touch panel includes a plurality of repetitive units whose structures are respectively shown in FIG. 3 to FIG. 8. With reference to FIG. 12 to FIG. 17, each repetitive unit 10 can serve as the smallest unit and can be repetitively arranged to constitute one complete sensing unit. In other embodiment of the invention, the sensing unit may include one or more repetitive units of different types.

FIG. 3 is a schematic diagram illustrating a repetitive unit according to an embodiment of the invention. The repetitive unit 10 includes a first electrode 12 and a second electrode 14, and the first electrode 12 and the second electrode 14 are electrically independent from each other and respectively connected to two channels. That is, one repetitive unit 10 corresponds to one pair of channels.

In FIG. 3, only one repetitive unit is shown. In the following embodiments respectively shown in FIG. 12 to FIG. 17, the repetitive units 10 may be sequentially arranged in a first direction D1, so as to constitute a bar-shaped sensing unit. Here, the first direction D1 is perpendicular to the second direction D2. In other words, in the entire sensing units, the repetitive units 10 are continuously arranged, and the first electrodes 12 may be shaped as sawteeth, forks, combs, or fingers. Similarly, the second electrodes 14 may be shaped as sawteeth, forks, combs, or fingers.

A border line with a profile V1 shaped as an inverted letter V is between the first and second electrodes 12 and 14; in an embodiment of the invention, there may be a space shaped as an inverted letter V between the first and second electrodes 12 and 14. Preferably, the repetitive unit 10 is symmetrical about its median M1 parallel to the second direction D2, and therefore the V-shaped profile V1 is shaped as the regular letter V. However, the invention is not limited thereto, and the repetitive unit 10 may have an asymmetrical structure, i.e., the V-shaped profile V1 may be shaped as an irregular letter V in an embodiment of the invention. In other embodiments of the invention, the profile V1 may be shaped as a letter U (a regular letter U or an irregular letter U).

To be specific, the first electrode 12 includes two first branch regions 12A, and the second electrode 14 is constituted by one second branch region 14A. The two first branch regions 12A are located on two edges of the repetitive unit 10 in the first direction D1, and the second branch region 14A is located between the two first branch regions 12A. Note that the two edges of the first repetitive unit 10 in the first direction D1 respectively belong to the first branch regions of the first electrode.

According to the present embodiment, the two first branch regions 12A of the first electrode 12 both have the pointed structure of which one end is narrow and the other is wide, and the narrowest portion N12A and the widest portion B12A of the pointed structure are respectively adjacent to a first side S1 and a second side S2. Likewise, the second branch region 14A of the second electrode 14 has the pointed structure of which one end is narrow and the other is wide, and the narrowest portion N14A and the widest portion B14A of the pointed structure are respectively adjacent to the second side S2 and the first side S1. Here, the narrowest portion of the pointed structure may not be sharp and may be shaped as an arc.

According to the present embodiment, each of the first branch regions 12A has the partial pointed structure, i.e., half the second branch region 14A, while the second branch region 14A has the complete pointed structure. The width of each first branch region 12A with the partial pointed structure is smaller than the width of the second branch region 14A with the complete pointed structure. In an embodiment of the invention, the maximum width of each first branch region 12A with the partial pointed structure may be half the maximum width of the second branch region 14A with the complete pointed structure, which should however not be construed as a limitation to the invention. Additionally, the partial pointed structure and the complete pointed structure described herein may be a right triangle and a non-right triangle, respectively. Moreover, two partial pointed structures may be combined to form one complete pointed structure, which should however not be construed as a limitation to the invention.

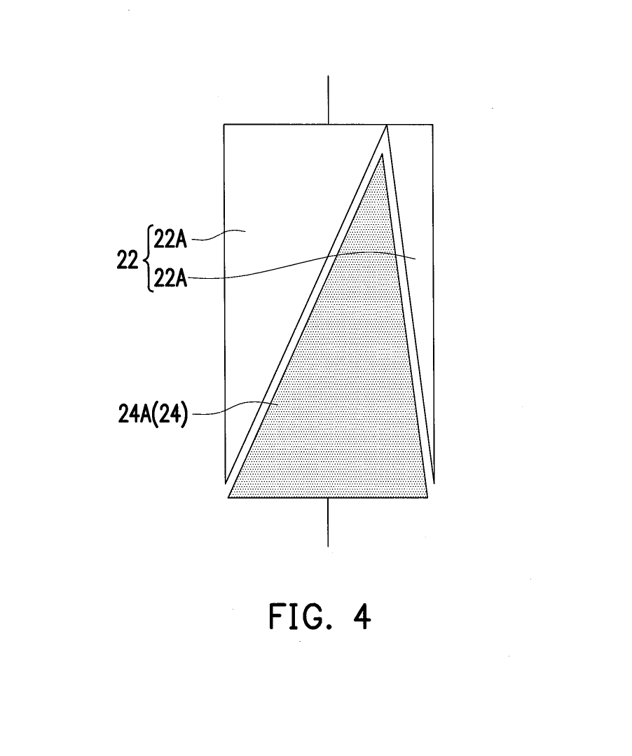

It should be mentioned that the partial pointed structures described herein are right triangles, and the complete pointed structure is an isosceles triangle constituted by two right triangles with the identical base and height. Nevertheless, in another embodiment, e.g., the embedment shown in FIG. 4, the complete pointed structure may be a triangle constituted by two right triangles with different bases and heights, and the triangle described herein is neither an isosceles triangle nor a right triangle.

FIG. 4 is a schematic diagram illustrating a repetitive unit according to another embodiment of the invention. Similar to the embedment shown in FIG. 3, the embodiment provided herein discloses the repetitive unit 20 that includes a first electrode 22 and a second electrode 24, the first electrode 22 includes two first branch regions 22A, and the second electrode 24 is constituted by one second branch region 24A. In the present embodiment, the two first branch regions 22A are located on two respective sides of the second branch region 24A and respectively have the partial pointed structure, and the second branch region 24A has the complete pointed structure. The descriptions of the partial pointed structure and the complete pointed structure are provided in the previous embodiment shown in FIG. 3 and thus will not be further provided hereinafter. Nevertheless, in the present embodiment, the complete pointed structure is a triangle constituted by two right triangles with different bases and heights, and the triangle described herein is neither an isosceles triangle nor a right triangle. Besides, the bases and heights of the two first branch regions 22A with the partial pointed structures have different dimensions. A border line with a profile shaped as an irregular, inverted letter V is between the first and second electrodes 22 and 24; in an embodiment of the invention, there may be a space shaped as an irregular, inverted letter V between the first and second electrodes 22 and 24.

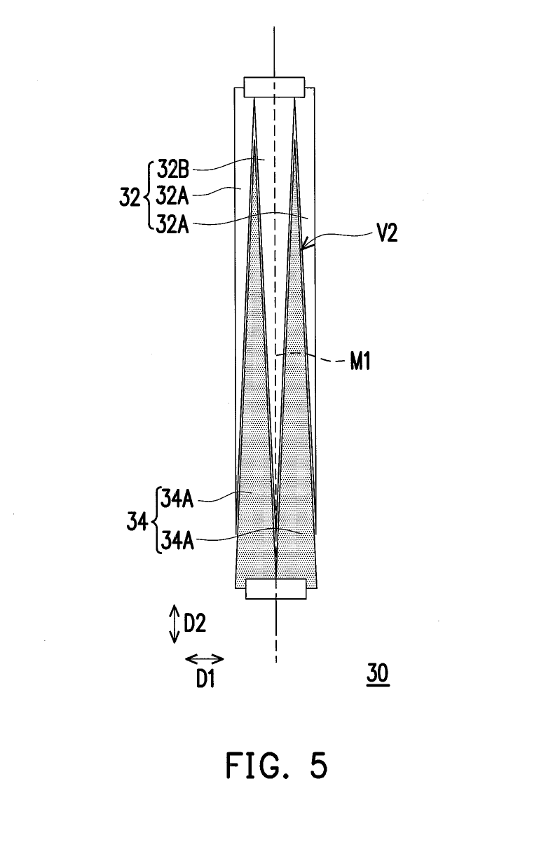

FIG. 5 is a schematic diagram illustrating a repetitive unit 30 according to another embodiment of the invention. The repetitive unit 30 includes a first electrode 32 and a second electrode 34, and the first electrode 32 and the second electrode 34 are electrically independent from each other and respectively connected to different channels. That is, the repetitive unit 30 corresponds to one pair of channels as well. The first electrode 32 includes two first branch regions 32A and one first branch region 32B, and the second electrode 34 includes two second branch regions 34A. Here, the first branch regions 32A and 32B and the second branch regions 34A all have the pointed structure. Specifically, each of the two first branch regions 32A has the partial pointed structure, and each of the first branch region 32B and the second branch regions 34A has the complete pointed structure. The descriptions of the partial pointed structure and the complete pointed structure are provided in the previous embodiments and thus will not be further provided hereinafter. From another perspective, each of the two first branch regions 32A is shaped as a right triangle, and each of the first branch region 32B and the second branch regions 34A is shaped as a non-right triangle.

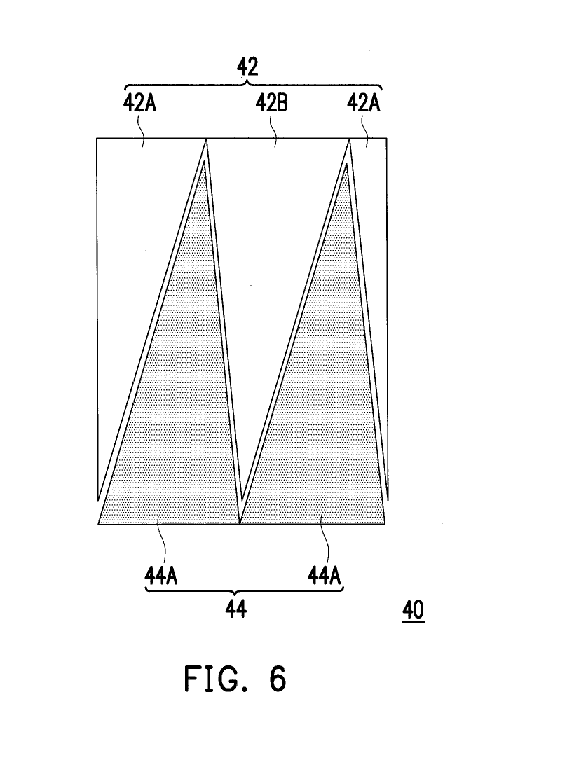

The two first branch regions 32A with the partial pointed structure are located on two edges of the repetitive unit 30 in the first direction D1, and the first branch region 32B with the complete pointed structure is located between the two first branch regions 32A. Each of the second branch regions 34A (respectively having the complete pointed structure) is located between two adjacent first branch regions 32A and 32B, i.e., the first branch regions 32A and 32B and the second branch regions 34A are alternately arranged in the first direction D1. Thereby, the border line or the space between the first and second electrodes 32 and 34 has a double-V shaped profile V2, and the repetitive unit 30 is symmetrical about its median M2 parallel to the second direction D2. In FIG. 5, the complete pointed structure is an isosceles triangle, while the invention is not limited thereto. In FIG. 6, the repetitive unit 40 includes a first electrode 42 and a second electrode 44, the first electrode 42 includes two first branch regions 42A and one first branch region 42B, and the second electrode 44 includes two second branch regions 44A. In the present embodiment, the two first branch regions 42A are located on two respective sides of the repetitive unit 40 and respectively have the partial pointed structure, and the second branch regions 44A and the first branch region 42B each have the complete pointed structure. The descriptions of the partial pointed structure and the complete pointed structure are provided in the previous embodiments and thus will not be further provided hereinafter. Nevertheless, in the present embodiment, the complete pointed structure is a triangle constituted by two right triangles with different bases and heights, and the triangle described herein is neither an isosceles triangle nor a right triangle. Besides, the widths and heights of the two first branch regions 42A with the partial pointed structures have different dimensions.

In the embodiments shown in FIG. 3 and FIG. 4, the number of the first branch regions with the complete pointed structure is 0, and the number of the second branch regions with the complete pointed structure is 1. By contrast, In the embodiments shown in FIG. 5 and FIG. 6, the number of the first branch regions with the complete pointed structure is 1, and the number of the second branch regions with the complete pointed structure is 2. The difference between the embodiments shown in FIG. 3 and FIG. 4 and the embodiments shown in FIG. 5 and FIG. 6 lies in the number the first branch regions with the complete pointed structure and the number of the second branch regions with the complete pointed structure. In other embodiments of the invention, the number of the first branch regions with the complete pointed structure and the number of the second branch regions with the complete pointed structure can be 3 or more, which can be determined according to different designs.

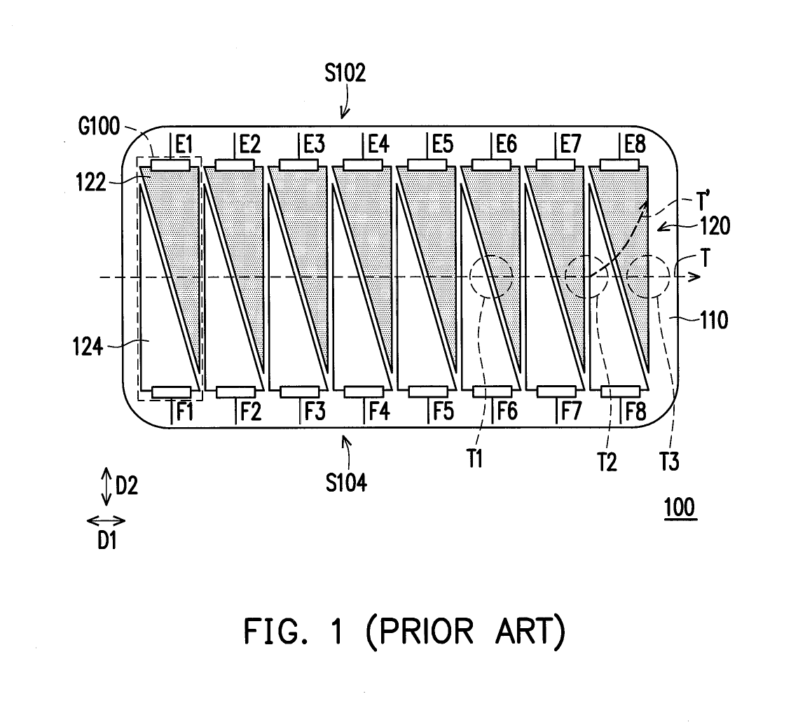

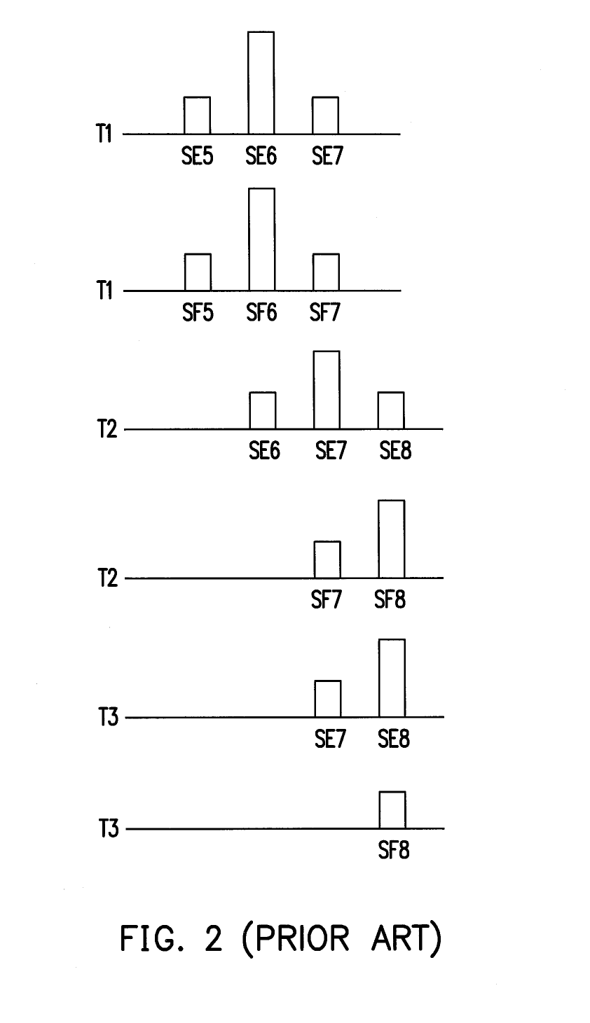

The similarities among the embodiments shown in FIG. 3 to FIG. 6 lie in that the two edges of the repetitive unit in the first direction D1 respectively belong to the branch regions of the same electrode (i.e., the first electrode in the previous embodiments). In FIG. 1, the two edges of each repetitive unit respectively belong to the branch regions of different electrodes. Besides, the first branch regions of each repetitive unit described above include two partial pointed structures respectively arranged on two sides of the repetitive unit and a certain number of complete pointed structures located between the two partial pointed structures; the second branch regions of each repetitive unit described above include the same number (e.g., a positive integer) of complete pointed structures respectively arranged between the first branch regions. The similarities among the embodiments shown in FIG. 3 to FIG. 6 also include the at least one V-shaped or U-shaped border line between the first and second electrodes; that is, the border line deviating from a positive direction along the first direction D1 and a border line deviating from a negative direction along the first direction between the first and second electrodes are paired. On the contrary, in FIG. 1, the border line deviating from the positive direction along the first direction D1 is located on one edge of the repetitive unit.

To sum up, in an i^{th} repetitive unit, the first branch region (e.g., the first branch region 32B or 42B) includes two partial pointed structures respectively located on two edges of the i^{th} repetitive unit and (Zi−1) complete pointed structures. The second branch regions (e.g., the second branch regions 32A or 42A) have Zi complete pointed structures, and Zi may be any positive integer.

In the previous embodiments, each repetitive unit is merely connected to one pair of channels and is defined as a first-type repetitive unit for explanatory purposes. Besides, the structure connected to one pair of channels is further defined as a basic unit. As shown in FIG. 3 to FIG. 6, the repetitive units 10 to 40 are first-type repetitive units, and thus each of the repetitive units 10 to 40 is constituted by one basic unit.

Each basic unit of the first-type repetitive unit respectively shown in FIG. 3 to FIG. 6 equivalently has Xi sets of complete pointed structures. Here, Xi=Pi, and Pi is a positive integer. Particularly, in the basic unit of the first-type repetitive unit, the first electrode has (Xi+1) first branch regions, and (Xi−1) first branch regions (e.g., the first branch region 32B or 42B) of the (Xi+1) first branch regions have the complete pointed structure. Two of the first branch regions are respectively located on two different sides of the basic unit and have the partial pointed structure (e.g., the first branch regions 12A, 22A, 32A, or 42A), while the two first branch regions respectively located on two different sides of the basic unit may be equivalently combined to form one complete pointed structure. Accordingly, in one basic unit, the first electrode equivalently has ((Xi−1)+1)==Xi complete pointed structures. Additionally, in the basic unit of the first-type repetitive unit, the second electrode has Xi second branch regions, each of which has the complete pointed structure (e.g., the first branch region 14A, 24A, 34A, or 44A). Hence, the number of the second branch region with the complete pointed structure is Xi. Namely, the second electrode has Xi complete pointed structures as well. In the basic unit of the first-type repetitive unit, the first electrode equivalently has Xi complete pointed structures, and the second electrode actually has Xi complete pointed structures; hence, the basic unit of the first-type repetitive unit equivalently has Xi sets of complete pointed structures.

Therefore, the repetitive unit 10 depicted in FIG. 3 or the basic unit equivalently has one set of complete pointed structure (including the two first branch regions 12A with the partial pointed structures and one second branch region 14A with the complete pointed structure). The repetitive unit 20 shown in FIG. 4 or the basic unit equivalently has one set of complete pointed structure, and the repetitive unit 30 shown in FIG. 5 and the repetitive unit 40 shown in FIG. 6 or the basic unit each equivalently have two sets of complete pointed structures. In other embodiments of the invention, each basic unit of the first-type repetitive unit can equivalently have three, four, or more sets of complete pointed structures.

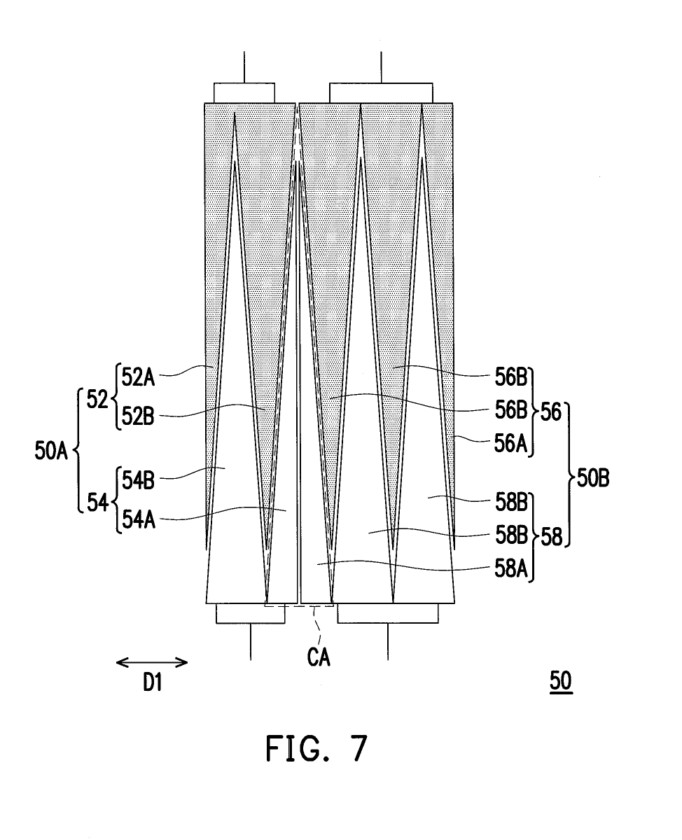

In the following embodiments shown in FIG. 7 to FIG. 11, each repetitive unit is connected to two pairs of channels and is defined as a second-type repetitive unit for explanatory purposes.

FIG. 7 is a schematic diagram illustrating a repetitive unit 50 according to another embodiment of the invention. The repetitive unit 50 includes first electrodes 52 and 56 and second electrodes 54 and 58. The first electrode 52 and the second electrode 54 are electrically independent from each other and are respectively connected to different channels in one pair of channels. The first electrode 56 and the second electrode 58 are electrically independent from each other and are respectively connected to different channels in the other pair of channels.

Although the first electrodes 52 and 56 are electrically insulated from each other, the first electrodes 52 and 56 are connected to the channels on the same side. Each of the first electrodes 52 and 56 includes two first branch regions 52A and 56A (individually having a partial pointed structure) and the first branch regions 52B and 56B (individually having a complete pointed structure). The first branch regions 52A and 52B are electrically connected and constitute the first electrode 52, and the first branch regions 56A and 56B are electrically connected and constitute the other first electrode 56. Besides, the two first branch regions 52A and 56A individually having a partial pointed structure are respectively located on two edges of the repetitive unit 50 in the first direction D1, i.e., the outermost portion of the repetitive unit 50 is constituted by the branch regions each having the partial pointed structure. The first branch regions 52B and 56B each having the complete pointed structure are located between the first branch regions 52A and 56A.

Similarly, although the second electrodes 54 and 58 are electrically insulated from each other, the second electrodes 54 and 58 are connected to the channels on the same side. Each of the second electrodes 54 and 58 includes two second branch regions 54A and 58A (individually having a partial pointed structure) and the second branch regions 54B and 58B (individually having a complete pointed structure).

The second branch regions 54A and 58A individually having a partial pointed structure are adjacent to each other and equivalently constitute one complete pointed structure CA. The second branch region 54B having the complete pointed structure is located between the first branch regions 52A and 52B, and the second branch region 58B having the complete pointed structure is located between the adjacent first branch regions 56A and 56B.

The two edges of the repetitive unit 50 in the first direction D1 respectively belong to the first branch regions of the first electrode. The first branch regions of the first electrode include two partial pointed structures (52A and 56A) respectively arranged on two sides of the repetitive unit and three complete pointed structures (52B, 56B, and 56B) located between the two partial pointed structures; the second branch regions of the second electrode include four complete pointed structures respectively arranged between the first branch regions of the first electrode.

In other embodiments, there may be more complete pointed structures. That is, in the i^{th} repetitive unit, the first branch region includes two partial pointed structures respectively located on two edges of the i^{th} repetitive unit and (Zi−1) complete pointed structures. The second branch regions have Zi complete pointed structures and do not have any partial pointed structure, and Zi may be any positive integer.

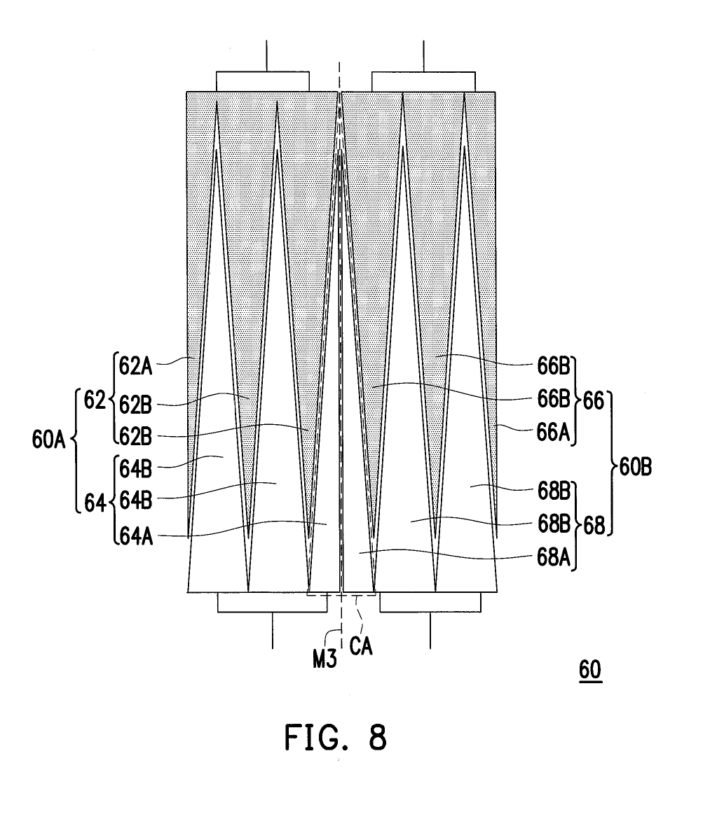

In view of the above, the structure connected to one pair of channels is defined as one basic unit. Therefore, in FIG. 7, the repetitive unit 50 is divided into the basic unit 50A and the basic unit 50B. The repetitive unit 50 corresponds to two pairs of channels, and each of the basic units 50A and 50B respectively corresponds to one pair of channels. Even though the basic units 50A and 50B described in the present embodiment have different structures, the basic units may have the same structure in other embodiments, e.g., in the embodiment shown in FIG. 8.

Specifically, the basic unit 50A includes the first electrode 52 and the second electrode 54, and the basic unit 50B includes the first electrode 56 and the second electrode 58.

According to the present embodiment, the basic unit 50A equivalently includes 1.5 set of complete pointed structure. The first branch region 52B of the first electrode 52 and the second branch region 54B of the second electrode 54 both have the complete pointed structure and constitute one set of complete pointed structure, and the first branch region 52A of the first electrode 52 and the second branch region 54A of the second electrode 54 both have the partial pointed structure and constitute 0.5 set of complete pointed structure. Namely, the first electrode 52 of the basic unit 50A has the first branch region 52B with Xi complete pointed structures and the first branch region 52A with one partial pointed structure, and the first branch region 52A with the partial pointed structure is located on one of the two opposite sides of the basic unit 50A. The second electrode 54 of the basic unit 50A has the second branch region 54B with Xi complete pointed structures and the second branch region 54A with one partial pointed structure, and the second branch region 54A with the partial pointed structure is located on the other one of the two opposite sides of the basic unit 50A. Here, Xi is a positive integer; as to the basic unit 50A, Xi is 1.

According to the present embodiment, the basic unit 50B equivalently includes 2.5 sets of complete pointed structures. The two first branch regions 56B of the first electrode 56 and the two second branch regions 58B of the second electrode 58 have the complete pointed structure and constitute two sets of complete pointed structures, and the first branch region 56A of the first electrode 56 and the second branch region 58A of the second electrode 58 both have the partial pointed structure and constitute 0.5 set of complete pointed structure. Namely, the first electrode 56 of the basic unit 50B has the first branch regions 56B with Xi complete pointed structures and the first branch region 56A with one partial pointed structure, and the first branch region 56A with the partial pointed structure is located on one of the two opposite sides of the basic unit 50B. The second electrode 58 of the basic unit 50B has the second branch regions 58B with Xi complete pointed structures and the second branch region 58A with one partial pointed structure, and the second branch region 58A with the partial pointed structure is located on the other one of the two opposite sides of the basic unit 50B. Here, Xi is a positive integer; as to the basic unit 50B, Xi is 2.

In the embodiment shown in FIG. 7, if the repetitive unit is the second-type repetitive unit and includes two basic units 50A and 50B, each of the basic units 50A and 50B respectively includes 1.5 set of complete pointed structure and 2.5 sets of complete pointed structures. In another embodiment of the invention, if the repetitive unit is the second-type repetitive unit and includes two basic units, each of the basic unit respectively includes Xi sets of complete pointed structures. Here, Xi=(Pi+0.5), and Pi is a positive integer; as to the basic unit 50A or 50B, Pi is 1 or 2, respectively.

In FIG. 8, the repetitive unit 60 is divided into the basic unit 60A and the basic unit 60B and is the second-type repetitive unit. The repetitive unit 60 described in the present embodiment includes the first electrodes 62 and 66 and the second electrodes 64 and 68. The first electrode 62 and the second electrode 64 are electrically independent from each other and are respectively connected to different channels in one pair of channels. The first electrode 66 and the second electrode 68 are electrically independent from each other and are respectively connected to different channels in the other pair of channels.

Although the first electrodes 62 and 66 are electrically insulated from each other, the first electrodes 62 and 66 are connected to the channels on the same side. Each of the first electrodes 52 and 56 includes two first branch regions 62A and 66A (individually having a partial pointed structure) and the first branch regions 62B and 66B (individually having a complete pointed structure). Similarly, although the second electrodes 64 and 68 are electrically insulated from each other, the second electrodes 64 and 68 are connected to the channels on the same side. Each of the second electrodes 64 and 68 includes two second branch regions 64A and 68A (individually having a partial pointed structure) and the second branch regions 64B and 68B (individually having a complete pointed structure).

The two edges of the repetitive unit 60 in the first direction D1 respectively belong to the first branch regions of the first electrode. The first branch regions of the first electrode include two partial pointed structures (62A and 66A) respectively arranged on two sides of the repetitive unit and four complete pointed structures (62B, 62B, 66B, and 66B) located between the two partial pointed structures; the second branch regions of the second electrode include five complete pointed structures respectively arranged between the first branch regions of the first electrode.

The embodiment shown in FIG. 8 differs from the embodiment shown in FIG. 7 because the basic units 60A and 60B depicted in FIG. 8 have the same number of sets of complete pointed structures. Namely, the basic unit 60A includes the first electrode 62 and the second electrode 64, the first electrode 62 includes the first branch region 62A with one partial pointed structure and the first branch regions 62B with two complete pointed structures, and the second electrode 64 includes the second branch region 64A with one partial pointed structure and the second branch regions 64B with two complete pointed structures. Thereby, the basic unit 60A has 2.5 sets of complete pointed structures. Similarly, the basic unit 60B includes the first electrode 66 and the second electrode 68, the first electrode 66 includes the first branch region 66A with one partial pointed structure and the first branch regions 66B with two complete pointed structures, and the second electrode 68 includes the second branch region 68A with one partial pointed structure and the second branch regions 68B with two complete pointed structures. As such, the basic unit 60B has 2.5 sets of complete pointed structures as well.

With reference to FIG. 7 and FIG. 8, the basic units of the repetitive unit may each have different numbers of sets of the complete pointed structures or the same number of set of the complete pointed structure. Besides, the number of sets of the complete pointed structure in each basic unit may be adjusted according to actual requirements. Here, FIG. 7 shows the basic unit 50A with 1.5 set of complete pointed structure and the basic unit SOB with 2.5 sets of complete pointed structures, and FIG. 8 shows the basic unit 60A with 2.5 sets of complete pointed structures and the basic unit 60B with 2.5 sets of complete pointed structures; however, the invention is not limited thereto. In another embodiment of the invention, each basic unit can have Xi sets of complete pointed structures. Here, Xi=(Pi+0.5), and Pi is any positive integer.

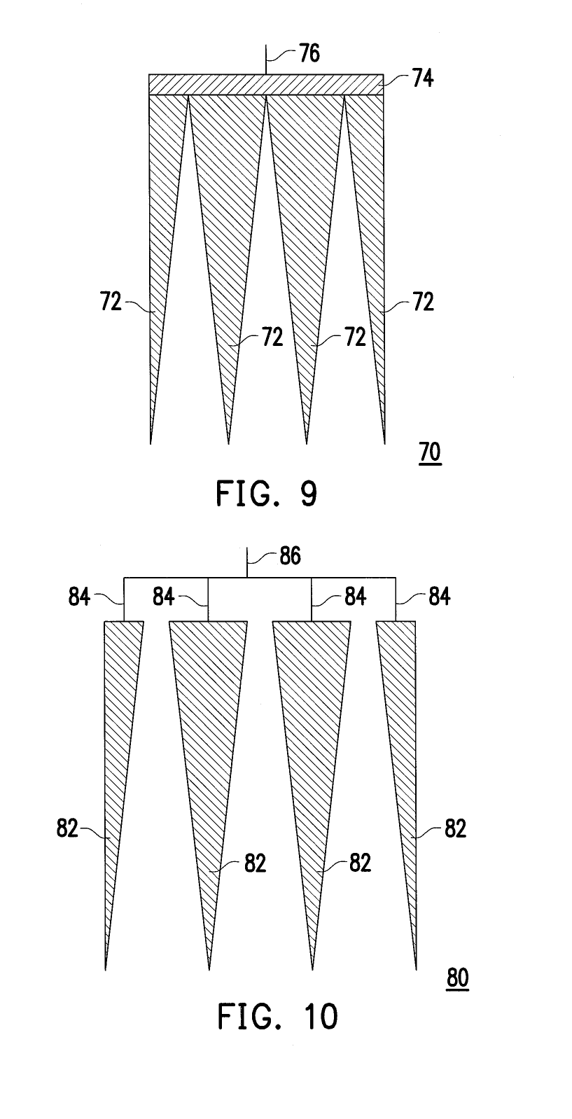

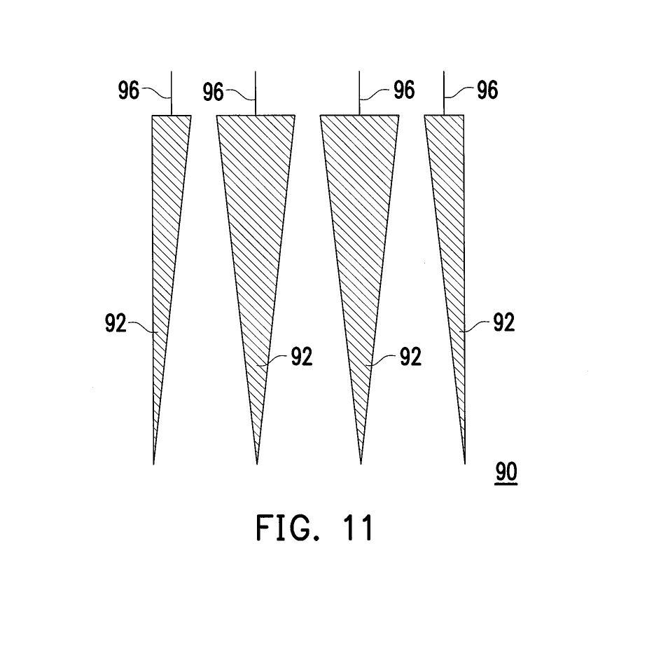

In the previous embodiments, each electrode is constituted by plural branch regions and corresponds to one pair of channels. The connection of the branch regions in one single electrode may be implemented in different manners. FIG. 9 to FIG. 11 illustrate connections of branch regions according to several embodiments of the invention. In FIG. 9, one single electrode 70 may include plural branch regions 72, one substrate region 74, and one connection line 76. The widest portion of each branch region 72 is connected to the substrate region 74, such that the branch regions 72 are electrically connected together. One end of the connection line 76 is connected to the substrate region 74, and the other end of the connection line 76 is connected to one pair of channels in the driving circuit. In addition, the branch regions 72, the substrate region 74, and the connection line 76 can be constituted by the same electrode layer; however, in another embodiment, the connection line 76 can be selectively constituted by another electrode layer. In FIG. 10, one single electrode 80 may include plural branch regions 82, plural mutually connected lines 84, and one connection line 86. One end of each mutually connected line 84 is connected to one of the corresponding branch regions 82, and the other end is connected to other mutually connected lines 84. The mutually connected lines 84 are connected by the connection line 86, and thereby the branch regions 82 can be electrically connected to one pair of channels in the driving circuit through the connection line 86. In FIG. 11, the electrode 90 includes plural branch regions 92 and plural connection lines 96. The connection lines 96 are structurally connected to the branch regions 92 and are not in physical contact with one another. Since the connection lines 96 connected to the driving circuit are conducted to the same channel, the branch regions 92 can still be connected to the same channel.

In the following embodiments, the repetitive units described above may exemplarily serve as touch electrodes of the touch panel. As shown in FIG. 12 to FIG. 17, the gap or space between adjacent repetitive units or adjacent basic units indicates that the adjacent units are independent from each other, while the gap or space should not be construed as a limitation to the invention. FIG. 12 illustrates a touch panel according to an embodiment of the invention. With reference to FIG. 12, the touch panel 1000 includes a substrate 1100 and an electrode layer 1200. The substrate 1100 includes a first substrate region 1102. The electrode layer 1200 includes a plurality of first repetitive units 1210 and 1220. The first repetitive units 1210 and 1220 are sequentially arranged in a first direction D1 on the first substrate region 1102 of the substrate 1100. Each of the first repetitive units 1210 and 1220 corresponds to integral pairs of channels A1 to A8 and B1 to B8 of plural pairs of channels. Here, the channels A1 to A8 and B1 to B8 are paired, the i^{th} first repetitive unit is connected to the pair of the channels Ai and Bi, and i is 1 to 8 in the present embodiment.

Each of the first repetitive units 1210 includes a first electrode 1212 and a second electrode 1214. The first electrode 1212 and the second electrode 1214 are electrically independent from each other. Here, the first electrode 1212 includes two first branch regions 1212A and one first branch region 1212B, and the second electrode 1214 includes a plurality of second branch regions 1214A. The structural design of the first repetitive unit 1210 is the same as that of the repetitive unit 30 depicted in FIG. 5, and thus the arrangement, the dimensions, and the shape of the first branch regions 1212A and 1212B and the second branch regions 1214A are already described above with reference to FIG. 5. Specifically, the first branch regions 1212A and 1212B and the second branch regions 1214A are alternately arranged on the first substrate region 1102 of the substrate 1100, and two edges of each of the first repetitive units 1210 in the first direction D1 respectively belong to the first branch regions 1212A.

Each of the first repetitive units 1220 includes a first electrode 1222 and a second electrode 1224. The first electrode 1222 and the second electrode 1224 are electrically independent from each other. Here, the first electrode 1222 includes two first branch regions 1222A and two first branch regions 1222B, and the second electrode 1224 includes three second ranch regions 1224A. Specifically, the first branch regions 1222A and 1222B and the second branch regions 1224A are alternately arranged on the first substrate region 1102 of the substrate 1100, and two edges of each of the first repetitive units 1220 in the first direction D1 respectively belong to the first branch regions 1222A. Here, each of the first branch regions 1222A has the partial pointed structure, and each of the first branch regions 1222B has the complete pointed structure. Therefore, two of the first branch regions 1222A can be equivalently considered as one complete pointed structure.

The first repetitive units 1210 and 1220 are both the first-type repetitive units and each correspond to one pair of channels. Here, each first repetitive unit 1210 has two sets of complete pointed structures, and each first repetitive unit 1220 has three sets of complete pointed structures. According to the present embodiment, the touch panel 1000 includes two first repetitive units 1210 and six first repetitive units 1220 located between the two first repetitive units 1210. If the number of the complete pointed structures in the repetitive units is represented in an algebraic manner, the i^{th} first repetitive unit of the first repetitive units 1210 and 1220 equivalently has Xi sets of complete pointed structures; if X₁=X_{N}=P_{M}, X₂= . . . =X(_{N-1)}=P_{S}, and P_{M}<P_{S}. In the present embodiment of the invention, i is 1 to 8, N is 8, P_{M} is 2, and P_{S} is 3.

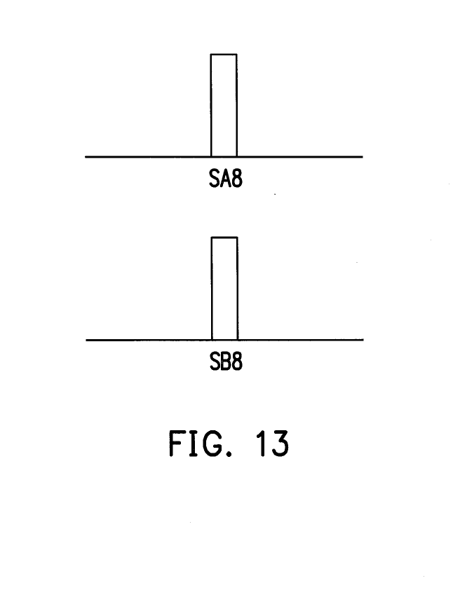

The overall width of the first repetitive units 1210 can be smaller than the overall width of the first repetitive units 1220 in the first direction D1, while the invention is not limited thereto. In the present embodiment, the repetitive units located on the edge are the first repetitive units 1210 with the relatively small width, and the outermost first branch region 1212A of the first repetitive unit 1210 has the partial pointed structure of which the maximum width is smaller than the width of the complete pointed structure. If a user touches the touch point T4, the signal SA8 received by the channel A8 corresponding to the first electrode 1222 and the signal SB8 received by the channel B8 corresponding to the second electrode 1224 are shown in FIG. 13. Since the strength of the signal SA8 is similar to the strength of the signal SB8, the touch panel 1000 is able to determine that the touch point T4 is approximately located at the center of the first repetitive unit 1210. The design of the electrode patterns described herein enables the drifting issue depicted in FIG. 1 to be resolved; that is, the touch action on the edge of the touch panel 1000 can be sensed in an accurate manner.

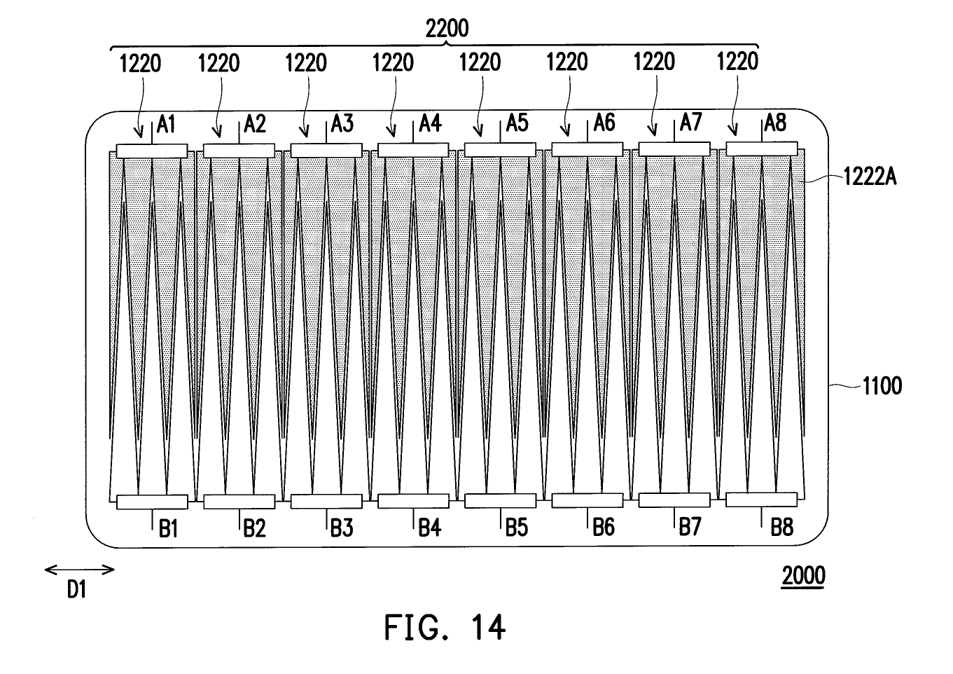

FIG. 14 is a schematic diagram illustrating a touch panel according to another embodiment of the invention. With reference to FIG. 14, the touch panel 2000 includes the substrate 1100 and an electrode layer 2200. The substrate 1100 is the same as that described in the previous embodiment shown in FIG. 12, and the electrode layer 2200 includes the first repetitive units 1220 described in the previous embodiment but does not include the first repetitive units 1210 depicted in FIG. 12. That is, the repetitive units of the electrode layer 2200 all have the same structure, i.e., the repetitive units are all first repetitive units 1220. The first repetitive units 1220 are sequentially arranged in the first direction D1. In view of the above, the first repetitive unit 1220 on the edge has the first branch region 1222A with the relatively small width, and the first branch region 1222A is located on the outermost side of the first repetitive unit 1220. When a touch action is sensed by the touch panel 2000, said design enables the conventional drifting issue to be resolved, and the touch action on the edge of the touch panel 2000 can be accurately sensed.

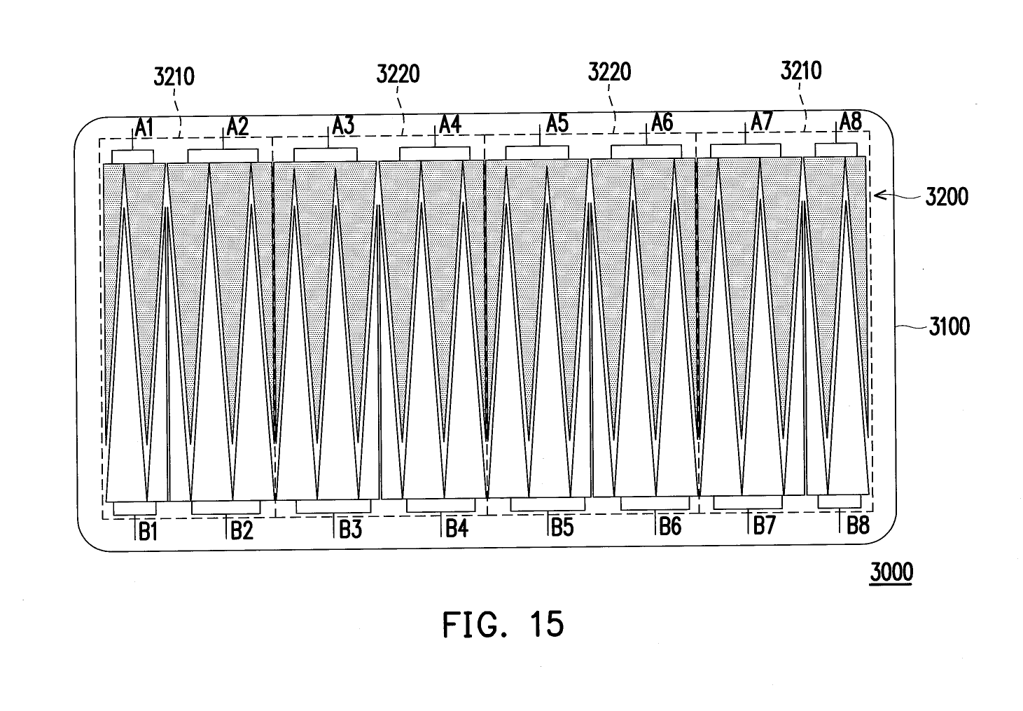

It can be learned from FIG. 12 and FIG. 14 that the first repetitive units in the same touch panel may or may not have the same structural design. Therefore, in other embodiments of the invention, one or more first-type repetitive units respectively shown in FIG. 3 to FIG. 6 may be selected and placed on one substrate, so as to constitute the touch panel. Hence, FIG. 12 and FIG. 14 serve to exemplify and do not serve to limit the invention. In addition, as shown in FIG. 12 and FIG. 14, the touch panels 1000 and 2000 both adopt the first-type repetitive units as the first repetitive units, which should however not be construed as a limitation to the invention. According to other embodiments of the invention, the second-type repetitive units respectively shown in FIG. 7 and FIG. 8 or modified second-type repetitive units may be selected to constitute the touch panel. FIG. 15 is a schematic diagram illustrating a touch panel according to still another embodiment of the invention. In FIG. 15, the touch panel 3000 includes a substrate 3100 and an electrode layer 3200 that includes two first repetitive units 3210 and two first repetitive units 3220. Here, each of the first repetitive units 3210 is the repetitive unit 50 shown in FIG. 7, and each of the first repetitive units 3220 is the repetitive unit 60 shown in FIG. 8. In addition, the two first repetitive units 3210 are located at the outermost sides, and thus the first repetitive units 3220 are both located between the two first repetitive units 3210.

As shown in FIG. 7 and FIG. 8, the first repetitive units 3210 and 3220 each have two basic units. Each of the basic units corresponds to integral pairs of channels A1 to A8 and B1 to B8 of plural pairs of channels. Here, the channels A1 to A8 and B1 to B8 are paired, the i^{th} basic unit is connected to the pair of the channels Ai and Bi, and i is 1 to 8 in the present embodiment. If the number of the complete pointed structures in the basic units is represented in an algebraic manner, the i^{th} basic unit of the basic units equivalently has Xi sets of complete pointed structures, Xi=(Pi+0.5), and Pi is a positive integer. In the present embodiment, for instance, P1 and P8 are 1, and P2 to P7 are 2; however, Pi can be any positive integer and may have a fixed value in another embodiment of the invention. That is, the number of sets of complete pointed structures included in each basic unit is not specifically limited. Besides, in the present embodiment, X₁=X_{N}=P_{M}, X₂= . . . =X(_{N-1})=P_{S}, and P_{M}<P_{S}. Here, N is 8, P_{M} is 1.5, and P_{S} is 2.5.

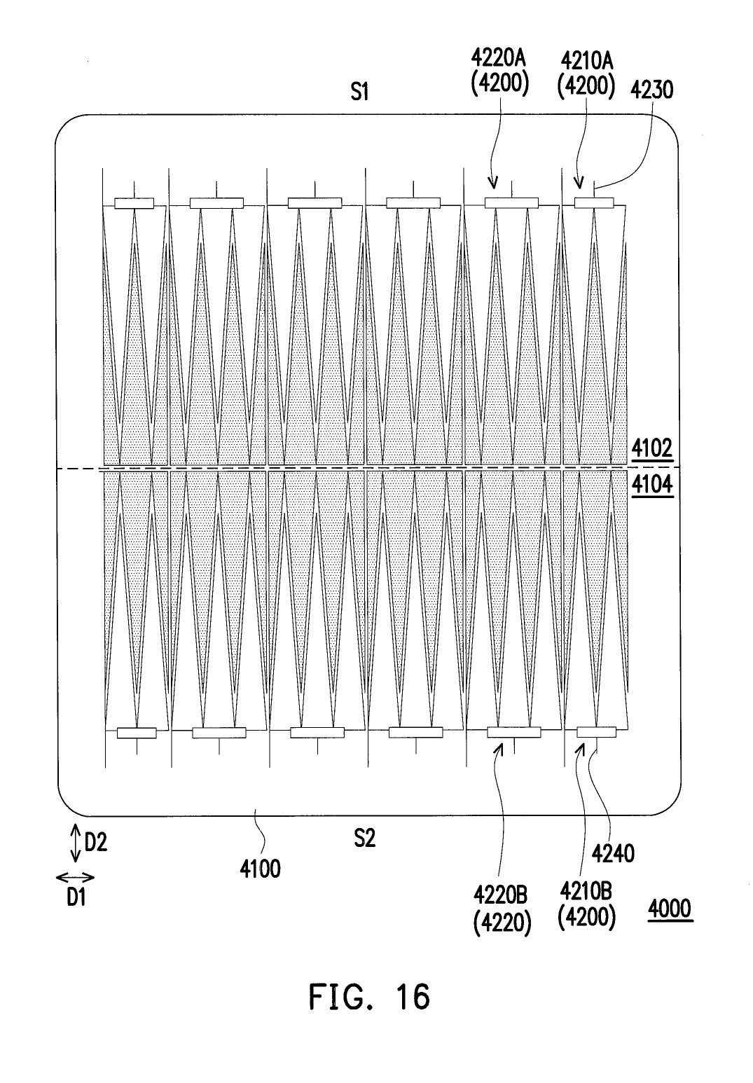

FIG. 16 is a schematic diagram illustrating a touch panel according to still another embodiment of the invention. With reference to FIG. 16, the touch panel 4000 includes a substrate 4100 and an electrode layer 4200. The substrate 4100 includes a first substrate region 4102 and a second substrate region 4104. The first substrate region 4102 has a plurality of first repetitive units 4210A and 4220A sequentially arranged in the first direction D1. The second substrate region 4104 has a plurality of second repetitive units 4210B and 4220B sequentially arranged in the first direction D1. The first repetitive units 4210A and 4220A and the first repetitive units 4220A and 4220B may be selected from any of the first repetitive units shown in FIG. 3 to FIG. 8. Hence, the number of sets of the complete pointed structures in the first repetitive units 4210A and 4220A may be the same or different. Similarly, the number of sets of the complete pointed structures in the second repetitive units 4210B and 4220B may be the same or different.

Additionally, the first repetitive units 4210A and 4220A in the first substrate region 4102 and the second repetitive units 4210B and 4220B in the second substrate region 4104 may be symmetrical. In the present embodiment, all of the first repetitive units 4210A and 4220A may be the first-type or second-type repetitive units described above. Likewise, all of the second repetitive units 4210B and 4220B may be the first-type or second-type repetitive units described above.

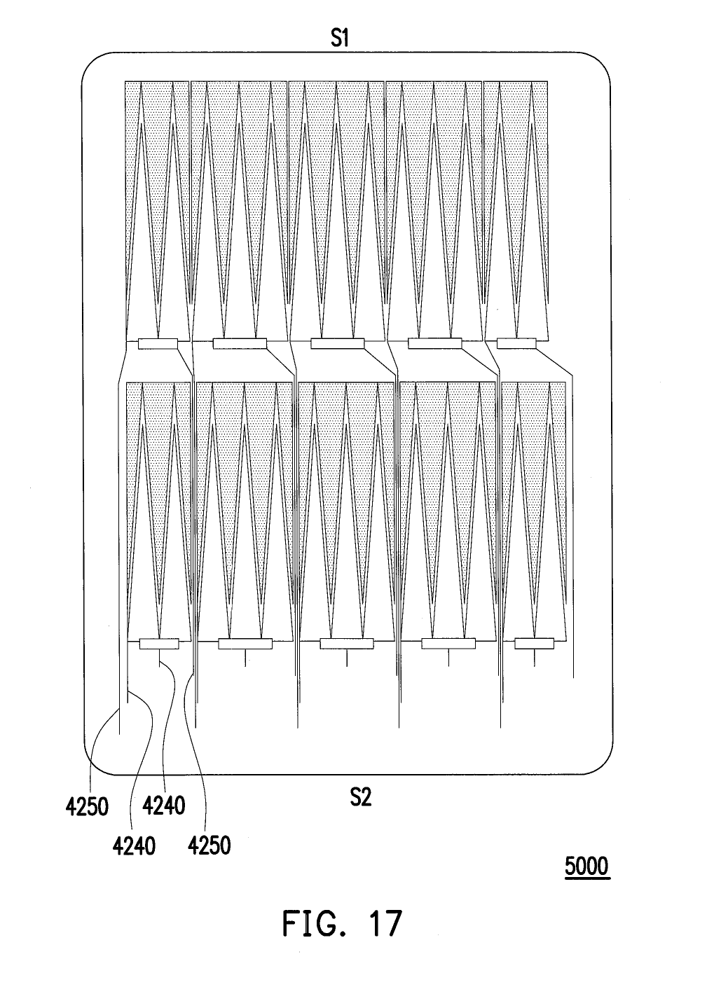

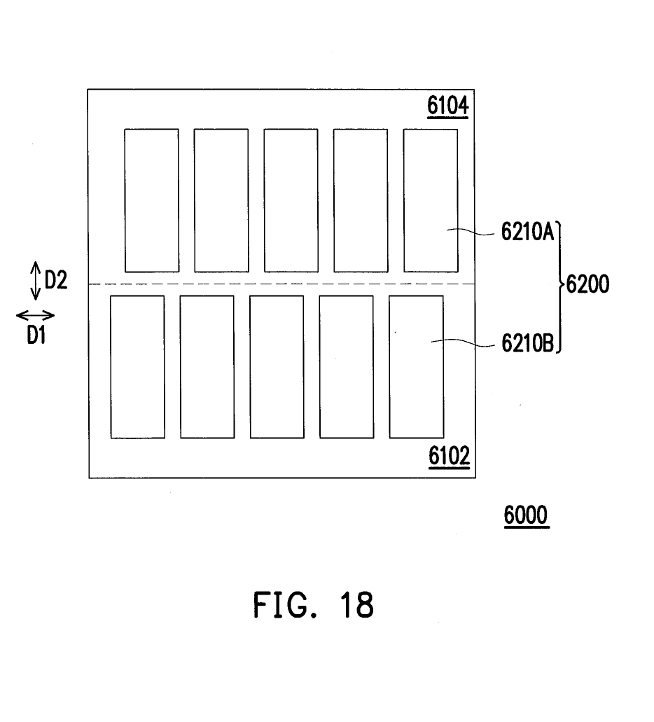

In the present embodiment, the electrode layer 4200 further includes connection lines 4230 connected to the first repetitive units 4210A and 4220A and connection lines 4240 connected to the second repetitive units 4210B and 4220B. Each of the connection lines 4230 extends from the first repetitive units 4210A and 4220A (respectively connected to the connection lines 4230) toward the first side S1, and each of the connection lines 4240 extends from the second repetitive units 4210B and 4220B (respectively connected to the connection lines 4240) toward the second side S1. Here, the first side S1 and the second side S2 are opposite sides of the touch panel 4000. However, the invention is not limited thereto. For instance, in the touch panel 5000 depicted in FIG. 17, the connection lines 4250 connected to the first repetitive units 4210A and 4220A and the connection lines 4240 connected to the second repetitive units 4210B and 4220B extend toward the second side S2, so as to connect the corresponding channels. Except for the extension direction of the connection lines 4250, the structural design of the touch panel 5000 is the same as that of the touch panel 4000 and thus will not be further described.

Besides, the symmetrical arrangement of the electrode layer 4200 in the first and second substrate regions 4102 and 4104, as shown in FIG. 16 and FIG. 17, is merely exemplary. In another embodiment of the invention, as shown in FIG. 8, the touch panel 6000 includes a substrate 6100 and an electrode layer 6200. The substrate 6100 includes a first substrate region 6102 and a second substrate region 6104, the electrode layer 6200 in the first substrate region 6102 has a plurality of first repetitive units 6210A sequentially arranged in the first direction D1, and the electrode layer 6200 in the second substrate region 6104 has a plurality of second repetitive units 6210B sequentially arranged in the first direction D1. Each of the first repetitive units 6210A and the second repetitive units 6210B can be selected from any of the repetitive units shown in FIG. 3 to FIG. 8; alternatively, each of the first repetitive units 6210A and the second repetitive units 6210B may be selected from any of the repetitive units shown in FIG. 3 to FIG. 8 and can then be modified. Moreover, according to the present embodiment, a layout of each of the first repetitive units 6210A of the electrode layer 6200 in the first substrate region 6102 and a layout of each of the second repetitive units 6210B of the electrode layer 6200 in the second substrate region 6104 respectively are asymmetrical to each other and are translationally shifted relative to each other along a second direction D2 perpendicular to the first direction D1.

To sum up, in the touch panel described in the embodiments of the invention, the repetitive units comprised of plural branch regions constitute the electrode layer for performing the sensing action, and each repetitive unit includes the branch regions each having the partial pointed structure on the edges of the repetitive unit. Thereby, if the user touches the edge of the touch panel, the touch points on the branch regions connected to different channels may be overlapped, so as to improve the sensing accuracy. As a result, the conventional “drifting” issue may be resolved.

What is claimed is:

1. A touch panel comprising:
a substrate comprising a first substrate region; and
an electrode layer comprising a plurality of first repetitive units sequentially arranged in a first direction on the first substrate region of the substrate,
wherein each of the first repetitive units corresponds to integral pairs of channels of plural pairs of channels and includes a first electrode and a second electrode independent from each other,
wherein the first electrode includes a plurality of first branch regions, the second electrode includes at least one second branch region, and the first branch regions and the at least one second branch region are alternately arranged on the first substrate region of the substrate,
wherein two edges of each of the first repetitive units in the first direction respectively belong to the first branch regions.

2. The touch panel according to claim 1, wherein each of the first repetitive units comprises one of a first-type repetitive unit corresponding to one pair of the channels and a second-type repetitive unit corresponding to two pairs of the channels.

3. The touch panel according to claim 2, wherein each of the first repetitive units is the first-type repetitive unit.

4. The touch panel according to claim 2, wherein each of the first repetitive units is the second-type repetitive unit.

5. The touch panel according to claim 1, wherein each of the first repetitive units is symmetrical about a median of each of the first repetitive units.

6. The touch panel according to claim 1, where each of the first branch regions in each of the first repetitive units has a pointed structure, a narrowest portion and a widest portion of the pointed structure are respectively adjacent to a first side and a second side of the touch panel, and each of the at least one second branch region has a pointed structure, and a narrowest portion and a widest portion of the pointed structure are respectively adjacent to the second side and the first side of the touch panel.

7. The touch panel according to claim 7, wherein in an i^{th} first repetitive unit of the first repetitive units, the first branch regions comprise two partial pointed structures respectively located at two sides of the i^{th} first repetitive unit and (Zi−1) complete pointed structures located between the two partial pointed structures, the at least one second branch region comprises Zi complete pointed structures respectively located between the first branch regions, and i and Zi are respectively a positive integer.

8. The touch panel according to claim 7, wherein each of the partial pointed structures is a right triangle.

9. The touch panel according to claim 7, wherein each of the complete pointed structures is a non-right triangle.

10. The touch panel according to claim 9, wherein the non-right triangle is an isosceles triangle.

11. The touch panel according to claim 1, wherein each of the first repetitive units is divided into at least one first basic unit respectively corresponding to one pair of the channels among N pairs of the channels.

12. The touch panel according to claim 11, wherein each of the first repetitive units is a first-type repetitive unit comprising one first basic unit or a second-type repetitive unit comprising two first basic units.

13. The touch panel according to claim 12, wherein an i^{th} first basic unit equivalently has Xi sets of complete pointed structures, i=1˜N, if the first repetitive unit to which the i^{th} first basic unit belongs is the first-type repetitive unit, Xi=Pi, if the first repetitive unit to which the i^{th} first basic unit belongs is the second-type repetitive unit, Xi=(Pi+0.5), and Pi is a positive integer.

14. The touch panel according to claim 13, wherein each of X₁ and X_{N} equals to P_{M}, each of X₂ to X_{N-1} equals to P_{S}, and P_{M}≦P_{S}.

15. The touch panel according to claim 13, wherein in the first basic unit belonging to the first-type repetitive unit:
the first branch regions comprise two partial pointed structures respectively located at two sides of the first repetitive unit and (Xi−1) complete pointed structures located between the two partial pointed structures, and
the at least one second branch region comprises Xi complete pointed structures respectively located between adjacent two of the two partial pointed structures and the (Xi−1) complete pointed structures of the first branch region, wherein Xi is a positive integer.

16. The touch panel according to claim 13, wherein in the first basic unit belonging to the second-type repetitive unit:
the first branch regions comprise Xi complete pointed structures and one partial pointed structure, and the partial pointed structure is adjacent to one of two sides of the at least one first basic unit, and
the at least one second branch region comprises Xi complete pointed structures respectively located between two of the first branch regions and one partial pointed structure being adjacent to the other one of the two sides of the at least one first basic unit, and Xi is a positive integer.

17. The touch panel according to claim 1, wherein the substrate further comprises a second substrate region, and the electrode layer further comprises a plurality of second repetitive units sequentially arranged in the first direction on the second substrate region of the substrate,
wherein each of the second repetitive units corresponds to integral pairs of channels of the plural pairs of channels and includes a third electrode and a fourth electrode independent from each other,
wherein the third electrode includes at least one third branch region, the fourth electrode includes at least one fourth branch region, and the at least one third branch region and the at least one fourth branch region are alternately arranged on the second substrate region of the substrate,
wherein two edges of each of the second repetitive units respectively belong to the third branch regions.

18. The touch panel according to claim 17, wherein a layout of the first repetitive units of the electrode layer on the first substrate region and a layout of the second repetitive units of the electrode layer on the second substrate region respectively are symmetrical to each other.

19. The touch panel according to claim 17, wherein a layout of the first repetitive units of the electrode layer on the first substrate region and a layout of the second repetitive units of the electrode layer on the second substrate region respectively are asymmetrical to each other and are translationally shifted relative to each other along a second direction perpendicular to the first direction.

20. The touch panel according to claim 1, wherein in each of the first repetitive units, each of the at least one second branch region of the second electrode is located between two adjacent first branch regions of the first branch regions of the first electrode in one of the first repetitive units.

21. The touch panel according to claim 1, wherein the first electrodes and the second electrodes in the first repetitive units are shaped as sawteeth, forks, combs, or fingers.

22. A touch panel comprising:
a substrate comprising a first substrate region; and
an electrode layer comprising a plurality of first repetitive units sequentially arranged in a direction on the first substrate region of the substrate,
wherein each of the first repetitive units corresponds to integral pairs of channels of plural pairs of channels and includes a first electrode and a second electrode independent from each other,
wherein the first electrode includes a plurality of first branch regions, the second electrode includes at least one second branch region, and the first branch regions and the at least one second branch region are alternately arranged on the first substrate region of the substrate,
wherein in each of the first repetitive units, each of the at least one second branch region of the second electrode is located between two adjacent first branch regions of the first branch regions of the first electrode in one of the first repetitive units.

23. A touch panel comprising:
a substrate comprising a first substrate region; and
an electrode layer comprising a plurality of repetitive units sequentially arranged in a first direction on the first substrate region of the substrate,
wherein each of the repetitive units corresponds to integral pairs of channels of plural pairs of channels and includes a first electrode and a second electrode independent from each other, and in one of the repetitive units, a border line shaped as a letter V or a letter U is between the first and second electrodes.

24. A touch panel comprising:
a substrate comprising a first substrate region; and
an electrode layer comprising a plurality of repetitive units sequentially arranged in a first direction on the first substrate region of the substrate,
wherein each of the repetitive units corresponds to integral pairs of channels of plural pairs of channels and includes a first electrode and a second electrode independent from each other, and in one of the repetitive units, a border line deviating from a positive direction along the first direction and a border line deviating from a negative direction along the first direction between the first and second electrodes are paired.
